(19) United States
(12) Patent Application Publication
(10) Pub. No.: US 2021/0081144 A1
(43) Pub. Date: Mar. 18, 2021

(54) ROM REWRITING MODULE CAPABLE OF EXECUTING REWRITING PROCESSING INDEPENDENTLY OF FIRMWARE

(71) Applicant: NEC Platforms, Ltd., Kawasaki-shi (JP)

(72) Inventor: Kentaro KOBUKI, Kanagawa (JP)

(73) Assignee: NEC Platforms, Ltd., Kawasaki-shi (JP)

(21) Appl. No.: 17/005,894

(22) Filed: Aug. 28, 2020

(30) Foreign Application Priority Data
Sep. 18, 2019 (JP) 2019-169198

(51) Int. Cl. G06F 3/06; G06F 21/31

(52) U.S. Cl. CPC G06F 3/0659; G06F 3/0604; H04W 88/02; G06F 21/31; G06F 3/0679

(57) ABSTRACT

A ROM rewriting module which is equipped in an electronic device together with a flash ROM. The electronic device operates in accordance with firmware stored in the flash ROM. The ROM rewriting module includes a ROM reader/writer and a writing control unit for executing writing processing for the flash ROM using the ROM reader/writer independently of the firmware.

This application is based upon and claims the benefit of priority from Japanese patent application No. 2019-169198, filed on Sep. 18, 2019, the disclosure of which is incorporated herein in its entirety by reference.

### TECHNICAL FIELD

This invention relates to rewriting of firmware stored in a flash ROM (Read Only Memory).

### BACKGROUND ART

There are various types of electronic devices in the world. Among them, there is a specific type of electronic devices each of which is configured to control a computer system incorporated in the electronic device by causing a processor to execute processing in accordance with firmware stored in the flash ROM. The firmware is also called a control program or ROM data. For various reasons, the firmware stored in the flash ROM may be corrupted.

In recent years, with the progress of introduction of IoT (Internet of Things), various types of IoT equipment have been used in a surrounding living environment. In electronic devices such as IoT equipment, there are many electronic devices each of which operates in accordance with the firmware stored in the flash ROM included therein. When a bug is present in the firmware and the electronic device falls into a state of being unable to start, there is a risk of imposing serious effects on life and business. It is therefore desired to reliably and easily recover the firmware in the flash ROM.

In preparation for corruption of the firmware, there is firmware having a recovery function which is capable of restoring the firmware if the firmware is partially corrupted. However, in general, such a recovery function is restricted in restoring the firmware. For instance, in a case where the corruption of the firmware exists in a part serving to perform the recovery function, it is impossible to carry out the restoring of the firmware. Even if the part serving to perform the recovery function is safe and uncorrupted, in a case where the corruption of the firmware exists in another part (for example, a boot block) which must be executed as a prerequisite for execution of the recovery function, it is impossible to carry out the restoring of the firmware.

In such a case where the corruption which cannot be restored by the recovery function of the firmware occurs in the firmware, the electronic device is often recovered, for example, in the following manner. Specifically, a support engineer carries out an operation of opening a case of the electronic device in direct contact with the electronic device and exchanging the flash ROM included in the case.

As an art related to the present invention, JP 2010-176386 A (which corresponds to US 2010/0191872 A2) discloses “a controller” comprising a file system driver having a power-failure-safe function, that is capable of preventing a failure of the file system when an interruption of power is caused due to a sudden power failure in changing data in the file system.

The power-failure-safe file system driver disclosed in JP 2010-176386 A operates on a control program after the controller starts in accordance with the control program. Accordingly, in order that the power-failure-safe system driver operates, it is necessary to succeed in starting the control program as the prerequisite therefor. In a case where there is a serious corruption in the control program stored in a flash memory (flash ROM) so that the starting of the control program is not completed or in a case where the control program starts in a state where an essential function for execution of the power-failure-safe file system driver is stopped, the power-failure-safe file system driver cannot operate normally. In those cases, the power-failure-safe file system driver cannot carry out rewriting of the control program (firmware) of the flash ROM.

### SUMMARY OF THE INVENTION

This invention has been made in view of the above-mentioned situation, and has an object to provide a technique which is capable of restoring firmware stored in a flash ROM regardless of a condition of corruption of the firmware.

According to an aspect of this invention, there is provided a ROM (Read Only Memory) rewriting module which is equipped, together with a flash ROM, in an electronic device operating in accordance with firmware stored in the flash ROM, the ROM rewriting module comprising a ROM reader/writer and a writing control unit configured to execute writing processing for the flash ROM using the ROM reader/writer independently of the firmware.

### Effect of Invention

According to the aspect of the present invention, it is possible to restore firmware stored in a flash ROM regardless of a condition of corruption of the firmware.

### BRIEF DESCRIPTION OF DRAWINGS

FIG. 1 is a block diagram for illustrating a firmware management system according to an example embodiment of the present invention;

FIG. 2 is a block diagram for illustrating a ROM rewriting module for use in the firmware management system illustrated in FIG. 1;

FIG. 3 is a block diagram for illustrating an external terminal for use in the firmware management system illustrated in FIG. 1;

FIG. 4 is a flow chart for use in explaining rewriting of a flash ROM in the firmware management system illustrated in FIG. 1;

FIG. 5 is a block diagram for illustrating a firmware management system according to a second modification of the above-mentioned example embodiment;

FIG. 6 is a block diagram for illustrating a ROM rewriting module according to a third modification of the above-mentioned example embodiment;

FIG. 7 is a flow chart for use in explaining an operation in a case where the external terminal reads ROM data out of the flash ROM in the third modification mentioned above; and

FIG. 8 is a block diagram for illustrating a ROM rewriting module according to a fourth modification of the above-mentioned example embodiment.

### DESCRIPTION OF EMBODIMENTS

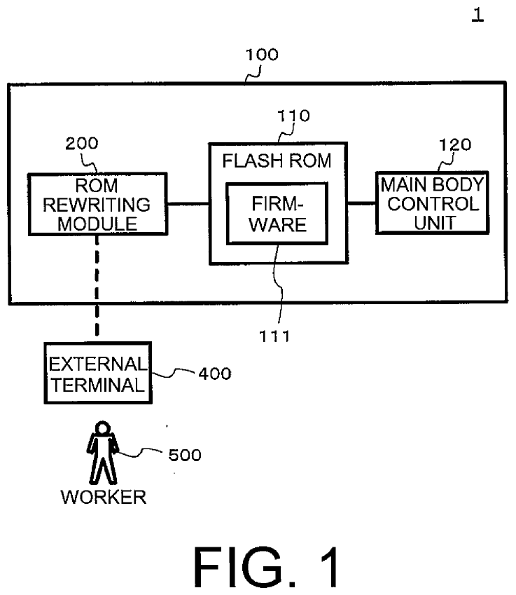

Referring to FIG. 1, description will be made of a firmware management system 1 according to an example embodiment of the present invention. The firmware management system 1 comprises an electronic device 100 and an external terminal 400.

The electronic device 100 comprises a flash ROM (Read Only Memory) 110 and a main body control unit 120. The flash ROM 110 comprises a nonvolatile storage device which is also called a flash memory or a flash EEPROM (Electrically Erasable Programmable ROM). The flash ROM 110 stores firmware 111 therein. The firmware is also called ROM data as described above. The main body control unit 120 comprises a computer system including a programmable processor such as a CPU (Central Processing Unit). The main body control unit 120 operates in accordance with the firmware 111.

Although various types of electronic equipment may be used as the electronic device 100, the electronic equipment comprising a wireless communication instrument is preferable for convenience of carrying out wireless communication as will later be described. The electronic device 100 may be any electronic equipment which operates in accordance with the firmware and which comprises the wireless communication instrument. Specifically, IoT (Internet of Things) equipment is suitable as the electronic device 100.

The electronic device 100 further comprises a ROM rewriting module 200. The ROM rewriting module 200 carries out wireless communication with the external terminal 400 and receives, from the external terminal 400, various instructions for managing the firmware 111. In accordance with the instructions, the ROM rewriting module 200 executes writing and/or reading for the flash ROM 110 to carry out update and restoration of the firmware 111 stored in the flash ROM 110. Although not shown in the figure, the electronic device 100 comprises a power source unit for supplying electric power to the main body control unit 120, the flash ROM 110, and the ROM rewriting module 200. It is conceivable that the power source unit has, for example, two electric power supply routes, i.e., a first electric power supply route and a second electric power supply route. The first electric power supply route supplies electric power to the main body control unit 120 and supplies electric power to the flash ROM 110 through the main body control unit 120. The second electric power supply route supplies electric power to the ROM rewriting module 200 and supplies electric power to the flash ROM 110 through the ROM rewriting module 200. As the power source unit has those electric power supply routes, when either the main body control unit 120 or the ROM rewriting module 200 operates, the flash ROM 110 can also operate.

In the firmware management system 1, the ROM rewriting module 200 is connected to the flash ROM 110 storing the firmware 111 for the electronic device 100. On rewriting the firmware 111 of the flash ROM 110, the ROM rewriting module 200 is used. A rewriting instruction for the flash ROM 110 and ROM file data are transmitted from the external terminal 400 in response to operation of a worker 500.

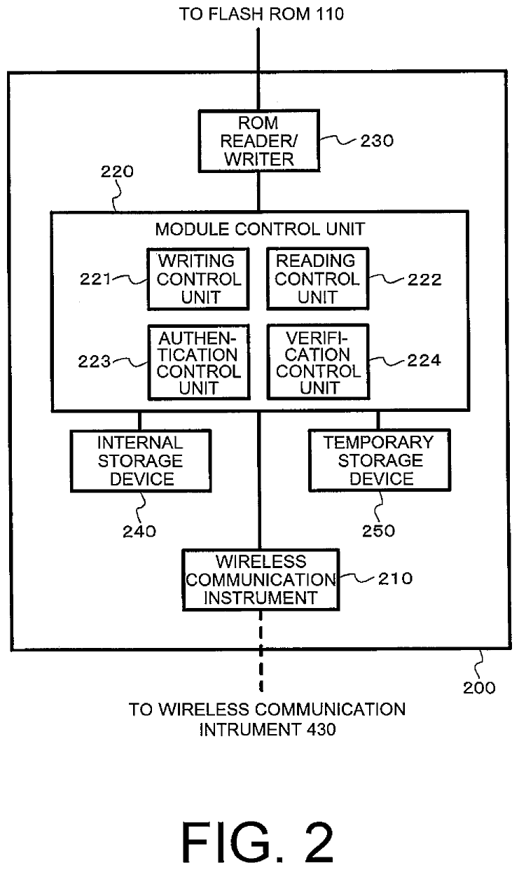

Referring to FIG. 2, description will be made about the ROM rewriting module 200. The ROM rewriting module 200 comprises a wireless communication instrument 210, a module control unit 220, a ROM reader/writer 230, an internal storage device 240, and a temporary storage device 250. The module control unit 220 is connected to each of the wireless communication instrument 210, the ROM reader/writer 230, the internal storage device 240, and the temporary storage device 250.

The wireless communication instrument 210 carries out, between the external terminal 400 and the wireless communication instrument 210, delivery and receipt of data such as the rewriting instruction, the ROM file data, and so on. The wireless communication instrument 210 is a communication instrument which is capable of carrying out wireless data communication with a wireless communication instrument 430 of the external terminal 400 which will later be described. As the wireless communication instruments 210 and 430, for example, a Bluetooth (registered trademark) transmitter-receiver, a wireless LAN (Local Area Network) interface device, a cellular phone, or the like may be used. It is noted here that a method of wireless communication is not specially limited in the present invention.

The module control unit 220 comprises a writing control unit 221, a reading control unit 222, an authentication control unit 223, and a verification control unit 224. The writing control unit 221 controls the ROM reader/writer 230 to execute processing for writing the ROM data to the flash ROM 110. The reading control unit 222 controls the ROM reader/writer 230 to execute processing for reading the ROM data out of the flash ROM 110. The authentication control unit 223 executes authentication processing for the worker 500 or the external terminal 400 which carries out wireless data communication via the wireless communication instrument 210. The verification control unit 224 executes verification processing based on ROM data which is preliminarily saved in the temporary storage device 250 and the ROM data which is read out of the flash ROM 110.

The ROM reader/writer 230 is controlled by the module control unit 220 and carries out writing/reading of the ROM data to/from the flash ROM 110.

The internal storage device 240 stores a serial number for distinguishing each individual ROM rewriting module 200. It is assumed that a different serial number is stored in an internal storage device 240 of a different electronic device 100. Thus, the serial number serves as identification information for identifying the ROM rewriting module 200.

The temporary storage device 250 temporarily saves the ROM data received from the external terminal 400 or the ROM data read by the ROM reader/writer 230.

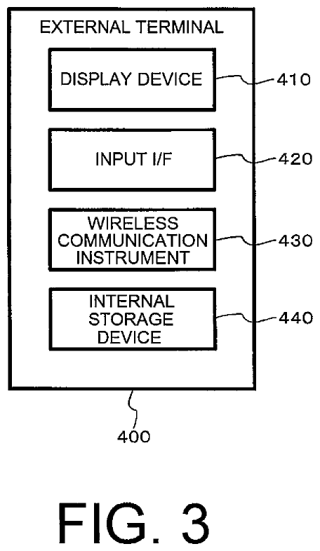

Referring to FIG. 3, description will be made about the external terminal 400. The external terminal 400 comprises an information communication terminal having a wireless communication function. The external terminal 400 comprises a display device 410, an input interface (hereinafter referred to as an “input I/F”) 420, the wireless communication instrument 430, and an internal storage device 440. The display device 410 is a display device such as an LCD (Liquid Crystal Display) device or an organic EL (Electro-Luminescence) display device. The input I/F 420 comprises a keyboard, a touch-panel display, or the like. The wireless communication instrument 430 is a communication instrument which is capable of carrying out wireless data communication with the above-mentioned wireless communication instrument 210. The internal storage device 440 is a storage device which has a nonvolatile storage area in at least part thereof.

As the external terminal 400, for example, a cellular phone, a smartphone, a tablet, a notebook computer, or the like may be used. The worker 500 is a service engineer for carrying out maintenance work of the electronic device 100 or the like. The worker 500 accesses the ROM rewriting module 200 by carrying out wireless communication using the external terminal 400 and carries out recovery work for the firmware 111 in the flash ROM 110.

Referring to FIGS. 2 and 3, further description will be made about the ROM rewriting module 200 and the external terminal 400. It is assumed here that the firmware 111 stored in the flash ROM 110 is corrupted to bring the electronic device 100 into a state of being unable to start and the worker 500 carries out recovery work for the firmware 111 using the external terminal 400.

The worker 500 is preliminarily assigned with authentication information (e.g. a user name, a password, and so on) indicating that the worker 500 is a regular worker.

Via the input I/F 420 such as the keyboard, the touch-panel display, and so on, the worker 500 inputs his/her own authentication information to request the electronic device 100 to carry out authentication. In response to the operation of the worker, the external terminal 400 transmits the authentication information to the ROM rewriting module 200 using the wireless communication instrument 430.

In the ROM rewriting module 200, when the wireless communication instrument 210 receives the authentication information from the wireless communication instrument 430 of the external terminal 400, the authentication control unit 223 determines whether or not the worker 500 is the regular worker based on the received authentication information. There are various types of authentication methods. For instance, the internal storage device 240 may preliminarily store authentication information of the regular worker and the authentication control unit 223 may compare the stored authentication information with the received authentication information. Alternatively, the authentication control unit 223 may transmit, to an external authentication server (not shown), the received authentication information using the wireless communication instrument 210 to request authentication of the worker and may carry out authentication based on an authenticated result received from the external authentication server. When the authentication control unit 223 determines that the worker 500 is the regular worker, the authentication control unit 223 gives the worker 500 authority to operate the ROM rewriting module 200 and notifies the external terminal 400 to that effect.

When the external terminal 400 receives notification to the effect that the authority for operation is given, the external terminal 400 displays to that effect on a screen of the display device 410 to notify the worker 500 to that effect. The worker 500 carries out operation of instructing to rewrite the ROM data through the input I/F 420. In response to this operation, the external terminal 400 transmits, through the wireless communication instrument 430, the ROM data and a writing instruction to the ROM rewriting module 200.

When the wireless communication instrument 210 receives the ROM data and the writing instruction, the module control unit 220 temporarily stores the received ROM data in the temporary storage device 250. The writing control unit 221 controls the ROM reader/writer 230 to rewrite the ROM data (firmware 111) stored in the flash ROM 110 based on the ROM data stored in the temporary storage device 250.

When the rewriting work by the writing control unit 221 is completed, the verification control unit 224 compares the ROM data stored in the temporary storage device 250 with the ROM data (firmware 111) in the flash ROM 110 after completion of the rewriting to confirm that there is no difference between those ROM data. The ROM rewriting module 200 transmits, through the wireless communication instrument 210, a notice of completion of the rewriting and a confirmed result to the external terminal 400. The external terminal 400 displays the completion of the rewriting and the confirmed result on the screen of the display device 400.

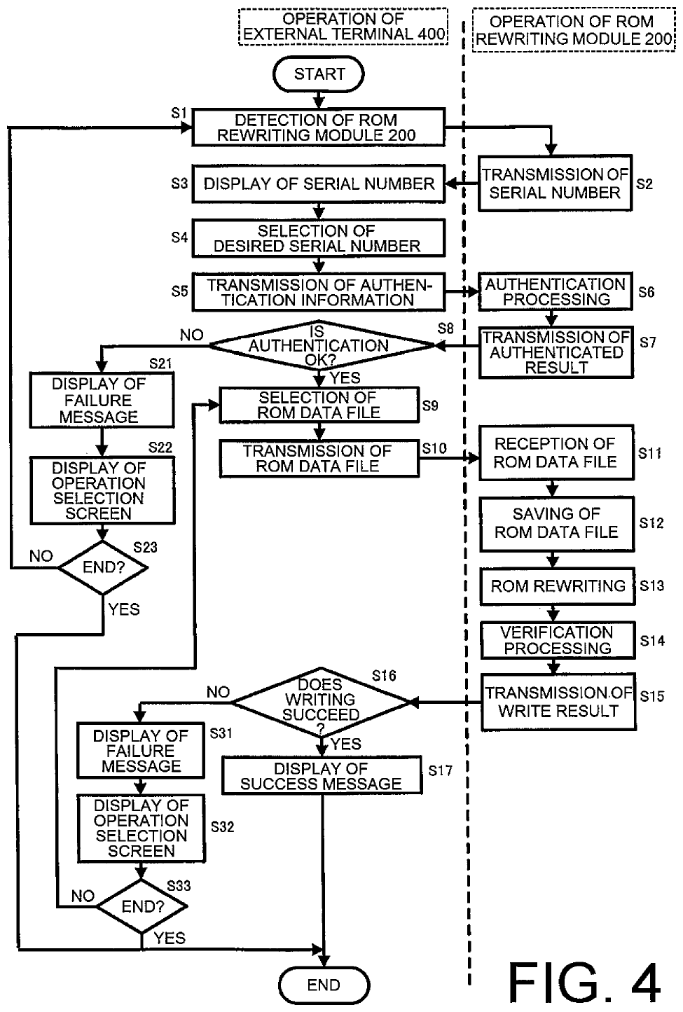

Next referring to FIG. 4, operations of the firmware management system 1 will be described more in detail. Using the input I/F 420 of the external terminal 400, the worker 500 carries out operation for starting management of the flash ROM 110 of the electronic device 100. In response to this operation, the wireless communication instrument 430 transmits a reply request signal to the electronic device 100 existing around the external terminal 400 (Step S1).

When the electronic device 100 exists within a communication radius of the wireless communication instrument 430, the ROM rewriting module 200 of the electronic device 100 transmits a serial number preliminarily assigned thereto towards the external terminal 400 (Step S2). It is assumed that the serial number is preliminarily stored in the internal storage device 240 as nonvolatile information.

In the external terminal 400, when the wireless communication instrument 430 receives the serial number, the display device 410 displays the serial number on the screen thereof (Step S3). In a case where a plurality of electronic devices 100 responds to the reply request signal transmitted in the Step S1, the external terminal 400 receives a plurality of serial numbers and displays these serial numbers on the screen of the display device 410.

Using the input I/F 420, the worker 500 carries out an operation of selecting the one serial number displayed on the screen of the display device 410 or any one of the plurality of serial numbers displayed on the screen thereof (Step S4).

As described above, the serial number is preliminarily stored in the internal storage device 240 of the ROM rewriting module 200. The serial number serves as the identification information for identifying the ROM rewriting modules 200 from one another as described above. Prior to the operation by the external terminal 400, the identification information is transmitted from the ROM rewriting module 200 to the external terminal 400. In this manner, in a case where a plurality of electronic devices 100 exist within the communication radius of the wireless communication instrument 430 of the external terminal 400, it is possible to select a specific ROM rewriting module to transmit an instruction thereto.

The wireless communication instrument 430 transmits, to the electronic device 100 being a transmitting source of the selected serial number as a destination, authentication information required to authenticate the worker 500 or the external terminal 400 (Step S5). The authentication information may be information which is inputted by the worker 500 through the input I/F 420 or may be information which is preliminarily stored in the internal storage device 440.

In the electronic device 100 specified by the serial number, the authentication control unit 223 executes authentication processing based on the authentication information received by the wireless communication instrument 210 (Step S6). For example, the authentication method may be a method using PKI (Private Key Infrastructure). By executing the authentication processing, it is possible to prevent any unauthorized person from rewriting the firmware 111 of the flash ROM 110. The wireless communication instrument 210 of the ROM rewriting module 200 transmits an authenticated result by the authentication control unit 223 to the external terminal 400 (Step S7).

As described above, prior to execution of reading/writing for the flash ROM 110, the authentication processing for the external terminal 400 or the worker 500 is carried out to produce the authenticated result. By accepting the operation only if the authenticated result is a success, it is possible to prevent the flash ROM 110 from being operated illegally.

When the authenticated result is OK (“YES” in the Step S8), the display device 410 of the external terminal 400 displays on the screen thereof that the authenticated result is a success and a message for requesting selection of a ROM data file to be transmitted. When the worker 500 sees the message, the worker 500 carries out, using the input I/F 420, an operation of selecting the ROM data file to be transmitted to the electronic device 100 (Step S9). Herein, it is assumed that the ROM data file to be selected is preliminarily stored in the internal storage device 440. Together with the selected ROM data file, the wireless communication instrument 430 transmits, to the electronic device 100, a rewriting instruction to rewrite the firmware 111 of the flash ROM 110 based on the ROM data file (Step S10).

On restoring the firmware 111, the worker 500 such as the service engineer can carry out restoring work of the firmware 111 without coming into direct contact with the electronic device 100, for example, in order to open the case of the electronic device 100 equipped with the ROM rewriting module 200. In addition, it is possible to carry out update of the firmware 111 collectively for a plurality of electronic devices 100 of the same type.

In the electronic device 100, when the wireless communication instrument 210 receives the ROM data file and the rewriting instruction (Step S11), the module control unit 220 saves the ROM data file in the temporary storage device 250 as volatile information (Step S12). In accordance with the rewriting instruction, the writing control unit 221 writes, using the ROM reader/writer 230, the ROM data file saved in the temporary storage device 250 into the flash ROM 110 (Step S13).

When the writing by the writing control unit 221 is completed, the reading control unit 222 reads, out of the flash ROM 110, the ROM data (firmware 111) which is presently stored therein. The verification control unit 224 compares the ROM data read by the reading control unit 222 with the ROM data saved in the temporary storage device 25 to carry out verification processing (Step S14). When the verification processing is completed, the wireless communication instrument 210 transmits, to the external terminal 400, a result of the verification processing as a write result (Step S15).

In the external terminal 400, when the wireless communication instrument 430 receives a write success as the write result (“YES” in Step S16), the display device 410 displays, on the screen thereof, a success message indicative of a success of the rewriting for the flash ROM 110 in the electronic device 100 (Step S17). When seeing the success message, the worker 500 can know that the rewriting for the flash ROM 110 succeeds.

When the external terminal 400 fails in the authentication in the Step S8 (“NO” in the Step S8), the display device 410 of the external terminal 400 displays, on the screen thereof, that the authenticated result is a failure (Step S21) and further displays an operation selection screen on the screen thereof (Step S22).

The worker 500, who sees this operation selection screen, carries out an operation through the input I/F 420. When the worker 500 carries out the operation to end firmware management (“YES” in the Step S23), the operation of the firmware management system 1 ends. When the worker 500 carries out the operation to continue the firmware management (“NO” in the Step S23), the external terminal 400 turns back to the Step S1 to continue the operation.

In a case of a failure of the writing in the Step S16 (“NO” in the Step S16), the display device 410 displays, on the screen thereof, a failure message indicative of the failure of the rewriting for the flash ROM 110 in the electronic device 100 (Step S31), and further displays the operation selection screen on the screen thereof (Step S32).

While the display device 410 displays the operation selection screen, when the worker 500 carries out the operation to end the firmware management through the input I/F 420 (“YES” in the Step S33), the operation of the firmware management system 1 ends. When the worker 500 carries out the operation to continue the firmware management (“NO” in the Step S33), the external terminal 400 turns back to the Step S9 to continue the operation.

According to the above-mentioned firmware management system 1, the rewriting for the flash ROM 110 is performed by the module control unit 220 which operates independently from both the main body control unit 120 and the firmware 111 without using the main body control unit 120 which operates in accordance with the firmware 111. Therefore, even if the firmware 111 currently stored in the flash ROM 110 is corrupted, it is possible to complete recovery of the firmware 111 regardless of a degree of the corruption. Especially, even if the firmware 111 is perfectly corrupted and therefore the main body control unit 120 does not operate at all, the firmware management system 1 can recover the firmware 111.

In addition, according to the above-mentioned firmware management system 1, the rewriting for the flash ROM 110 is performed by carrying out wireless communication between the ROM rewriting module 200 and the external terminal 400. Therefore, on carrying out the recovery work, the worker 500 is not required to directly touch the electronic device 100 with his/her hand. Since it is possible to carry out the recovery work if the ROM rewiring module 200 and the external terminal 400 are mutually communicable within the communication radius, the worker 500 can carry out the recovery work even if the worker 500 does not know an accurate position of the electronic device 100. Upon carrying out the recovery work, the worker 500 is not required to visually observe the electronic device 100. Therefore, according to the above-mentioned firmware management system 1, even if the electronic device 100 is installed in a loft of a building or embedded in a wall, the worker 500 can carry out the recovery work of the firmware without taking out the electronic device 100 in a state where it is connected to an operational environment.

Furthermore, according to the above-mentioned firmware management system 1, on carrying out the work, the worker 500 is not required to directly touch the electronic device 100 with his/her hand and it is therefore possible to improve a degree of freedom on installing the electronic device 100. In prior art, assuming maintenance work after installation, it is necessary to consider workability when an installing position of the electronic device is determined. In comparison with this, according to the firmware management system 1, the worker 500 is not required to directly touch the electronic device 100 with his/her hand. Therefore, the worker 500 can easily perform the work even if the electronic device 100 is installed at a position which is physically difficult to access, for example, at a high place such as the loft or inside the wall.

Hereinafter, description will proceed to modifications of the above-mentioned firmware management system 1.

(First Modification: Batch Update of Firmware of a Plurality of Electronic Devices)

In the above-mentioned firmware management system 1, description has been made on the assumption that the firmware 111 of the flash ROM 110 in one electronic device 100 is rewritten by using one external terminal 400. In comparison with this, in the first modification, the firmware 111 of the flash ROMs 110 in a plurality of electronic devices 100 is simultaneously rewritten by using one external terminal 400.

In the foregoing description with referring to FIG. 4, when the external terminal 400 receives a plurality of serial numbers from a plurality of electronic devices 100 around the external terminal itself (within the communication radius of the wireless communication instrument 430) (the Step S2) and displays the plurality of serial numbers on the screen of the display device 410 (the Step S3), the external terminal 400 selects one of the plurality of serial numbers in accordance with operation of the worker 500 (the Step S4) and transmits the authentication information (the Step S5).

In comparison with this, in the first modification, plural serial numbers are selected in the Step S4. All of the serial numbers displayed may collectively be selected. In the Step S5, the external terminal 400 transmits the authentication information to all of electronic devices 100 corresponding to the selected serial numbers. Regarding selection of the ROM data file in the Step S9, the externa terminal 400 may select ROM data files for the electronic devices 100, respectively, or the external terminal 400 may select the same ROM data file for all of the electronic devices 100.

According to the first modification, especially in a case where a plurality of electronic devices 100 of the same kind are installed, it is possible to collectively carry out update of the firmware. In this event, the worker 500 is not always required to visually confirm the respective electronic devices 100. In addition, the worker 500 is not required to carry out work by directly touching the respective electronic devices 100 with his/her hand.

(Second Modification: Checking of Falsification of Firmware)

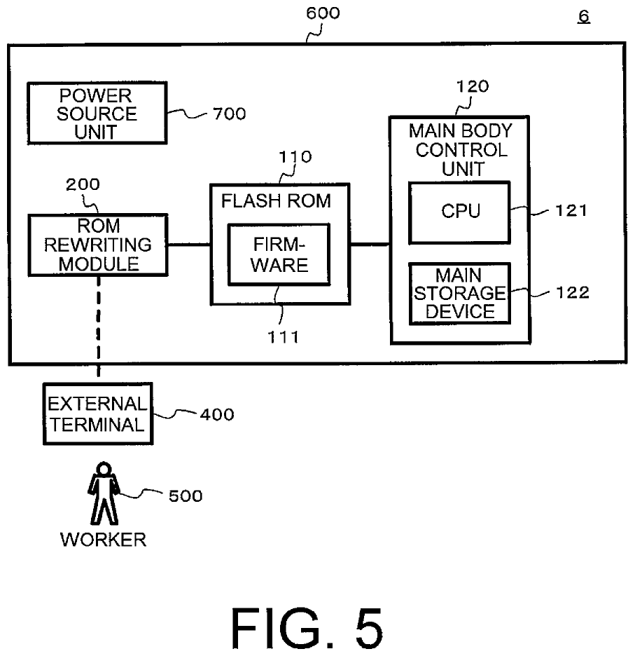

Referring to FIG. 5, description will be made of a firmware management system 6 which is a second modification of the firmware management system 1 illustrated in FIG. 1. The firmware management system 6 comprises an electronic device 600 and the external terminal 400. The electronic device 600 comprises a power source unit 700. The main body control unit 120 comprises a CPU (Central Processing Unit) 121 and a main storage device 122.

The power source unit 700 supplies electric power to the main body control unit 120, the flash ROM 110, and the ROM rewriting module 200. It is assumed that the power source unit 700 may supply the electric power separately to the ROM rewriting module 200 and to other components (the main body control unit 120 and the flash ROM 110). Hereinafter, in the electronic device 600, a part consisting of the main body control unit 120 and the flash ROM 110 will be called an electronic device main body. Inasmuch as it is possible to supply the electric power separately to the electronic device main body and to the ROM rewriting module 200, the electronic device main body and the ROM rewriting module 200 can operate independently of each other.

The CPU 121 controls operation of the electronic device 600 in accordance with a program stored in the main storage device 122. It is noted that the program stored in the main storage device 122 is identical with the firmware 111. The main storage device 122 comprises a volatile storage device. In order to accomplish the above-mentioned purpose, the CPU 121 reads the firmware 111 out of the flash ROM 110 to store the read firmware in the main storage device 122.

As described above, the ROM rewriting module 200 operates independently of the electronic device main body. Therefore, the power source unit 700 can stop electric power supply to the electronic device main body and can supply the electric power to the ROM rewriting module 200 alone.

In this event, the reading control unit 222 of the ROM rewriting module 200 can read the firmware 111 currently stored in the flash ROM 110 in a state where the main body control unit 120 securely suspends operation thereof. In this event, the power source unit 700 supplies the electric power to the flash ROM 110. Therefore, the reading control unit 222 can read the firmware 111 currently stored in the flash ROM 110 even in the state where the main body control unit 120 suspends its operation.

The main storage device 122 is the volatile storage device. Therefore, even if the main storage device 122 stores an illegal program just before stop of power supply, the electronic device 600 can perform a subsequent operation without being affected by the illegal program because power supply from the power source unit 700 stops. When the power source unit 700 supplies the electric power to the electronic device main body next time, it is ensured that the program executed by the CPU 121 is the firmware 111 read from the flash ROM 110 to the main storage device 122.

On the other hand, the ROM rewriting module 200 preliminarily receives, from the external terminal 400, the ROM data file corresponding to the firmware 111 in a normal state and stores the received ROM data file in the temporary storage device 250. Based on the firmware 111 read out of the flash ROM 110 under control of the reading control unit 222 and the ROM data file stored in the temporary storage device 250, the verification control unit 224 executes verification processing for deciding whether or not the firmware 111 in the flash ROM 110 is normal to produce a verified result.

The verified result is transmitted to the external terminal 400 via the wireless communication instrument 210. By the above-mentioned operation, the firmware management system 6 can confirm whether or not the firmware 111 currently stored in the flash ROM 110 is falsified.

More specifically, an operation of checking falsification of the firmware will be described as follows with reference to FIG. 4. The ROM rewriting operation in the Step S13 is skipped and the verification processing in the Step S14 is executed. In the Step S15, the verified result is transmitted in place of transmission of the write result.

By performing the above-mentioned checking of the falsification of the firmware, it is possible to detect the falsification of the firmware 111 stored in the flash ROM 110. By periodically performing the checking, it is possible to detect the falsification in an early stage so as to improve reliability of the operation of the electronic device 600.

Although the description has been made assuming that the power source unit 700 comprises a single power source device which can supply electric power to both of the electronic device main body and the ROM rewriting module 200 in this second modification, the electronic device main body and the ROM rewriting module 200 may be provided with separate power source devices which can supply the electric power independently of each other, respectively. For instance, a so-called AC (Alternating Current) adapter for extracting direct-current power from alternating-current power may be provided as a power source device for the electronic device main body whereas a secondary battery chargeable by the AC adapter may be provided as another power source for the ROM rewriting module 200.

(Third Modification: Acquisition of Data in Flash ROM)

In the above-mentioned example embodiment and the first modification, the description has been made about the updating of the firmware 111 stored in the flash ROM 110. In the second modification, the description has been made about the checking of falsification of the firmware. In a third modification, description will be made about acquisition of the firmware 111 stored in the flash ROM 110.

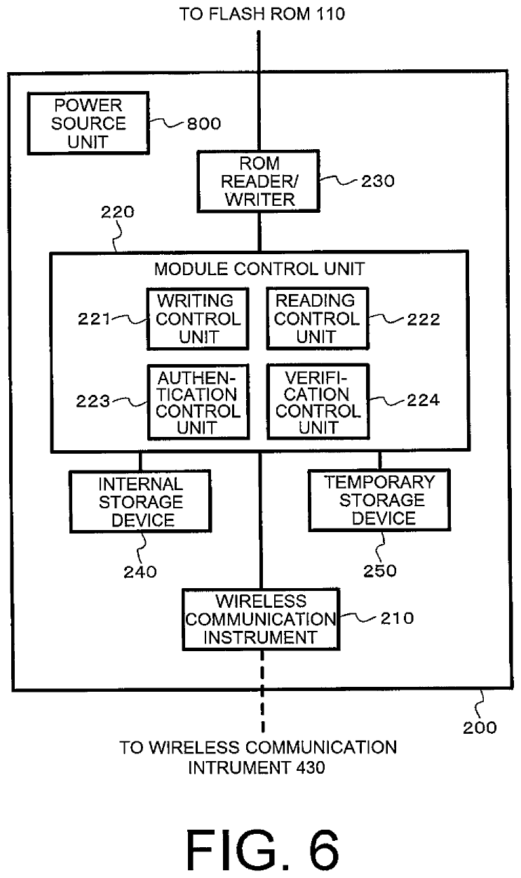

Referring to FIG. 6, in the third modification, the ROM rewriting module 200 further comprises a power source unit 800. The power source unit 800 comprises a power source device which can supply the electric power to the ROM rewriting module 200 independently of the power source for the electronic device main body. Like the power source unit 700 in the second modification, the power source unit 800 may be an AC adapter or a battery.

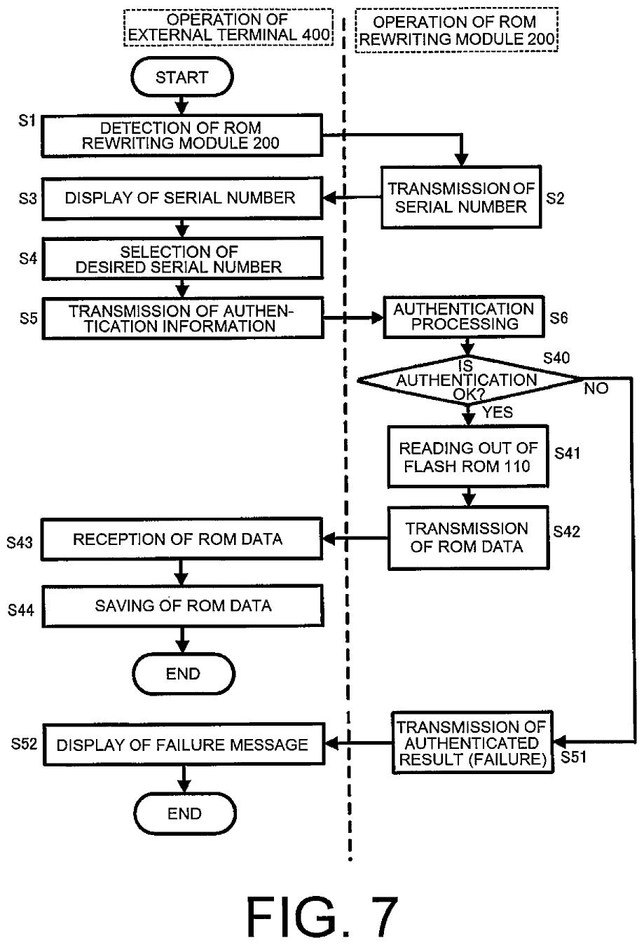

It is assumed that the electronic device 100 falls into a state of being unable to start for some reason. In this event, according to procedures as illustrated in FIG. 7, the external terminal 400 acquires the firmware 111 stored in the flash ROM 110.

The Steps S1 to S6 are similar to the respective steps of the same names which have been described previously. In the ROM rewriting module 200, when the authentication control unit 223 succeeds in the authentication (“YES” in a Step S40), the reading control unit 222 reads the firmware 111 out of the flash ROM 110 as ROM data (Step S41). The wireless communication instrument 210 transmits the read ROM data to the external terminal 400 (Step S42). The external terminal 400 receives the ROM data via the wireless communication instrument 430 (Step S43) and saves the received ROM data in the internal storage device 440 (Step S44). Thereafter, by carrying out analysis processing on the ROM data saved in the internal storage device 440, the worker 500 finds out the cause why the electronic device 100 falls into the state of being unable to start. The analysis processing may be carried out by using the external terminal 400. Alternatively, the analysis processing may be performed by copying or moving the ROM data in a desktop computer, a portable computer, a workstation, or the like.

When the authentication control unit 223 fails in the authentication in the Step S40 (“NO” in the Step S40), the authentication control unit 223 transmits, via the wireless communication instrument 210 to the external terminal 400, a failure message indicative of a failure of the authentication as the authenticated result (Step S51). When the external terminal 400 receives the failure message via the wireless communication instrument 430, the external terminal 400 displays the failure message on the screen of the display device 420 (Step S52).

According to the third modification, the external terminal 400 receives the firmware 111 when the electronic device 100 falls into the state of being unable to start, and treats the firmware 111 as the target for the analysis processing. It is therefore possible to provide a lead or hint to find out the cause.

(Fourth Modification: Loading the ROM Rewriting Module with a Battery)

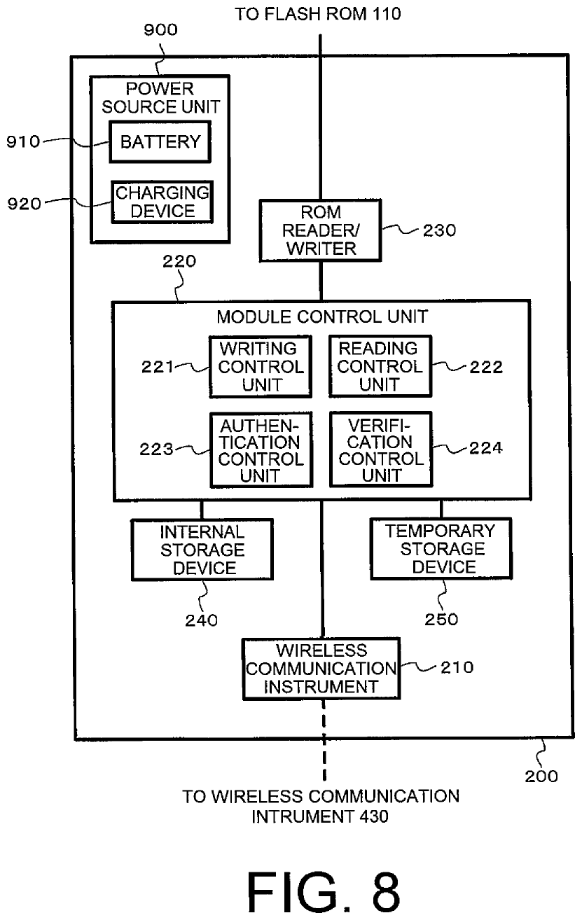

Referring to FIG. 8, in the fourth modification, the ROM rewriting module 200 comprises a power source unit 900 like in the above-mentioned third modification. However, in the fourth modification, the power source unit 900 comprises a battery 910 as a power source. In order to charge the battery 910, the power source unit 900 further comprises a charging device 920. The charging device 920 is supplied with electric power from an external power source (not shown) and charges the battery 910. The external power source comprises, for example, a power source device for the electronic device main body of the electronic device 100 or 600 which has the ROM rewriting module 200 therein.

It is preferable that the battery 910 has been charged at a time instant before completion of a manufacturing process of the electronic device having the ROM rewriting module 200 at the latest. This is because, if the battery 910 is charged, it is possible to rewrite the firmware 111 stored in the flash ROM 110 in the electronic device after being manufactured. For instance, in a case where the electronic device in a packaged state is kept in a warehouse of a factory after the electronic device is manufactured, it is possible to rewrite the firmware 111 stored in the flash ROM 110 in the electronic device in the packaged state.

While the present invention has been particularly shown and described with reference to the example embodiment thereof and the modifications thereof, the present invention is not limited to the example embodiment and the modifications. A part or a whole of the foregoing embodiment and the modifications may also be described as in the following supplementary notes. However, the following supplementary notes are not intended to limit the present invention.

[Supplementary Note 1]

A ROM (Read Only Memory) rewriting module (e.g. a ROM rewriting module 200) which is equipped, together with a flash ROM (e.g., a flash ROM 110), an electronic device (e.g. an electronic device 100) operating in accordance with firmware (e.g. firmware 111) stored in the flash ROM, the ROM rewriting module comprising:

a ROM reader/writer (e.g. a ROM reader/writer 230); and

a writing control means (e.g. a writing control unit 221) configured to execute writing processing for the flash ROM using the ROM reader/writer independently of the firmware.

[Supplementary Note 2]

The ROM rewriting module according to Supplementary Note 1, further comprising a communication means (e.g. a wireless communication instrument 210) configured to receive ROM data from another device,

wherein the writing control means is configured to write the received ROM data in the flash ROM using the ROM reader/writer.

[Supplementary Note 3]

The ROM rewriting module according to Supplementary Note 2, wherein the communication means carries out wireless communication.

[Supplementary Note 4]

The ROM rewriting module according to Supplementary Note 2, further comprising a storage device (e.g. an internal storage device 240) configured to store identification information for identifying the ROM rewriting module.

[Supplementary Note 5]

The ROM rewriting module according to any one of Supplementary Notes 2 to 4, further comprising an authentication means (e.g. an authentication control unit 223, an internal storage device 240) configured to authenticate, via the communication means, an external terminal or a user of the external terminal,

wherein the writing control means is configured to execute the writing processing for the flash ROM only in response to an instruction from the external terminal for which authentication by the authentication means succeeds.

[Supplementary Note 6]

An electronic device (e.g. an electronic device 100) comprising:

a flash ROM (e.g. a flash ROM 110) configured to store firmware (e.g. firmware 111); and

the ROM rewriting module (e.g. the ROM rewriting module 200) described in any one of Supplementary Notes 1 to 5,

wherein the electronic device is configured to operate in accordance with the firmware stored in the flash ROM.

[Supplementary Note 7]

The electronic device according to Supplementary Note 6, further comprising a firmware execution means (e.g. a CPU 121) configured to operate in accordance with the firmware,

wherein the firmware execution means is configured to operate independently of the writing control means.

[Supplementary Note 8]

A ROM (Read Only Memory) rewriting method comprising:

a storing step (e.g. a Step S12) of storing ROM data in a storage device; and

a writing step (e.g. a Step S13) of writing, in a flash ROM, the ROM data stored in the storage device using a ROM reader/writer,

wherein the writing step is executed independently of firmware which is preliminarily stored in the flash ROM.

[Supplementary Note 9]

The ROM rewriting method according to Supplementary Note 8, further comprising a communication step (e.g. a Step S11) of receiving ROM data from another device,

wherein the storing step stores, in the storage device, the ROM data received in the communication step,

wherein the writing step writes, in the flash ROM, the ROM data stored in the storage device using the ROM reader/writer.

[Supplementary Note 10]

A non-transitory computer readable recording medium for storing a ROM (Read Only Memory) rewriting program to cause a computer to execute:

a storing procedure (e.g. a Step S12) of storing ROM data in a storage device; and

a writing procedure (e.g. a Step S13) of writing, in a flash ROM, the ROM data stored in the storage device using a ROM reader/writer,

wherein the writing procedure is executed independently of firmware which is preliminarily stored in the flash ROM.

[Supplementary Note 11]

The non-transitory computer readable recording medium according to Supplementary Note 10, the ROM rewriting program further causing the computer to execute a communication procedure (e.g. a Step S11) of receiving ROM data from another device,

wherein the storing procedure stores, in the storage device, the ROM data received in the communication procedure,

wherein the writing procedure writes, in the flash ROM, the ROM data stored in the storage device using he ROM reader/writer.

1. A ROM (Read Only Memory) rewriting module which is equipped, together with a flash ROM, in an electronic device operating in accordance with firmware stored in the flash ROM, the ROM rewriting module comprising:
a ROM reader/writer; and
a writing control unit configured to execute writing processing for the flash ROM using the ROM reader/writer independently of the firmware.

2. The ROM rewriting module as claimed in claim 1, further comprising a communication unit configured to receive ROM data from another device,
wherein the writing control unit is configured to write the received ROM data in the flash ROM using the ROM reader/writer.

3. The ROM rewiring module as claimed in claim 2, wherein the communication unit carries out wireless communication.

4. The ROM rewriting module as claimed in claim 2, further comprising a storage device configured to store identification information for identifying the ROM rewriting module.

5. The ROM rewriting module as claimed in claim 2, further comprising an authentication unit configured to authenticate, via the communication unit, an external terminal or a user of the external terminal,
wherein the writing control unit is configured to execute the writing processing for the flash ROM only in response to an instruction from the external terminal for which authentication by the authentication unit succeeds.

6. An electronic device comprising:
a flash ROM configured to store firmware, and
the ROM rewriting module as claimed in claim 1,
wherein the electronic device is configured to operate in accordance with the firmware stored in the flash ROM.

7. The electronic device as claimed in claim 6, further comprising a firmware execution unit configured to operate in accordance with the firmware independently of the writing control unit.

8. A ROM (Read Only Memory) rewriting method comprising:
storing ROM data in a storage device; and
writing the ROM data in a flash ROM using a ROM reader/writer independently of firmware which is preliminarily stored in the flash ROM.

9. The ROM rewriting method as claimed in claim 8, further comprising receiving ROM data from another device,
wherein the storing stores the received ROM data in the storage device, and
wherein the writing writes, in the flash ROM, the ROM data stored in the storage device using the ROM reader/writer.

10. A non-transitory computer readable recoding medium for storing a program to cause a computer to execute:
a storing step of storing ROM (Read Only Memory) data in a storage device: and
a writing step of writing the ROM data in a flash ROM using a ROM reader/writer independently of firmware which is preliminarily stored in the flash ROM.
